(19) United States
(12) Patent Application Publication
(10) Pub. No.: US 2007/0211561 A1
(43) Pub. Date: Sep. 13, 2007

(54) Bail retainer for paint mixers

(75) Inventor: Steven Page, Palatine, IL (US)

Correspondence Address: MILLER, MATTHIAS & HULL, ONE NORTH FRANKLIN STREET, SUITE 2350, CHICAGO, IL, 60606, US

(73) Assignee: Fluid Management Operations, LLC, Wheeling, IL (US)

(21) Appl. No.: 11/372,308

(22) Filed: Mar. 9, 2006

(51) Int. Cl. B01F 11/00

(52) U.S. Cl. 366/113; 366/605

(57) ABSTRACT

A bail retainer is provided for use with a fluid mixer having a clamping area adapted to receive at least one container having a pivoting bail. The bail retainer includes an elastic member having a first fixed portion retained by the fluid mixer and a first free portion. A fastener is coupled to the elastic member first free portion. The elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

### BACKGROUND OF THE DISCLOSURE

1. Technical Field

The present disclosure generally relates to paint mixing apparatus, and more particularly relates to mechanisms for retaining and holding the paint can bail or handle in place during a mixing operation.

2. Description of the Related Art

A variety of motorized paint mixers are generally known in the art. A typical motorized paint mixer includes a base structure having a motor, belt and other components used to rapidly shake a can or pail of paint so that the paint can be sold to a customer in a thoroughly mixed condition. Most retail paint stores or hardware stores utilize one or more of these devices.

Despite the long use of motorized paint mixers, they suffer from a number of deficiencies related to the bail or handle attached to the paint can or pail. Specifically, paint mixers shake a paint can in a rapid and extremely violent manner. The bail is typically pivotably attached to the can so that it can be oriented with a middle portion above a top of the can to provide a convenient handle for transporting the can. When not in use as a handle, the bail may pivot from the top position in either direction so that the middle portion rests against a side of the can. Because the bail is free to move or pivot relative to the can, shaking of the paint can during mixing results in violent movement of the bail. The bail may strike the can or mixer structure with sufficient force to create significant noise in addition to that already generated by the paint mixer, and may also damage the clamping members between which the paint can is disposed during the shaking process. An unrestrained bail may also damage or mar the can and/or any labels applied to the can, much to the dismay of the manufacturer, trademark owner, and retailer. Still further, the bail may be damaged by forceful and repeated impacts with the can or mixer structure.

In one type of mixer, known as a vibratory-type paint mixer, the paint can is sandwiched between upper and lower clamping members. The clamping members are driven in a rapid reciprocating motion that is substantially along a linear path, which imposes a violent movement on the paint can resulting in a rapid and forceful up and down movement of the pivoting bail. The violent movement of the bail can cause damage to the clamping members, the paint mixer machine parts, the paint can label, and the bail. The same is true with respect to paint mixers that are not of the vibratory type. The unrestrained bail causes excessive noise and damage to the mixer machine as well as the paint container.

Retention of the bail is made more difficult with the recent increase in the variety of can shapes, sizes, and types. Previous bail retainers are knows that are suited for a particular can size or shape, such as a five gallon, generally cylindrical bucket. To increase brand recognition and meet consumer demands, however, paint manufacturers are using a wider variety of container styles and shapes. As a result, it would be advantageous for the paint mixer, and any bail retainer apparatus provided therewith, to be suited for use with a variety of can shapes, sizes, and styles.

It will be noted that this disclosure is not limited to paint mixers but to mixing machines of all types where a container is equipped with a pivoting bail or handle. Accordingly, this disclosure addresses the problem of how to adequately restrain or immobilize the bail during any shaking or mixing operation.

### SUMMARY OF THE DISCLOSURE

In satisfaction of the aforenoted needs, an improved bail retainer is disclosed for use with a fluid mixer having a clamping area adapted to receive at least one container having a pivoting bail. The bail retainer includes an elastic member having a first fixed portion retained by the fluid mixer and a first free portion, and a fastener is coupled to the elastic member first free portion. The elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

According to additional aspects, a fluid mixer is provided for use with at least one container having a pivoting bail. The fluid mixer includes a clamp assembly with a clamp base having an upper surface adapted to support a bottom of the container and a top plate adapted to engage a top of the container. The top plate is movable to adjust an axial spacing between the clamp base and the top plate and to provide a clamping force on the container when disposed therebetween. A clamping area is defined between the clamp base and the top plate. The mixer further includes a drive operably coupled to the clamp assembly and a bail retainer including an elastic member having a first fixed portion retained by the fluid mixer and a first free portion, and a fastener coupled to the elastic member first free portion. The elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

Accordingly to still further aspects, a fluid mixer is provided for use with at least one container having a pivoting bail. The fluid mixer includes a clamp base having an upper surface adapted to support a bottom of the at least one container and opposed first and second side walls depending from the upper surface, each of the first and second side walls including an aperture. A top plate is adapted to engage a top of the at least one container, wherein the top plate is movable to adjust an axial spacing between the clamp base and the top plate and provide a clamping force on the container when disposed therebetween, a clamping area being defined between the clamp base and the top plate. A drive is operably coupled to the clamp assembly, and an elastic member is sized for insertion through the side wall apertures, whereby engagement between the elastic member and the apertures in the first and second side walls define first and second fixed portions of the elastic member. The elastic member further includes at least one free portion, and a fastener is coupled to the elastic member first free portion. The elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

Other advantages and features of the disclosed embodiments and methods will be best understood upon reference to the accompanying drawings and detailed description that follows.

### BRIEF DESCRIPTION OF THE DRAWINGS

The disclosed bail retainer, mixing apparatus and method of mixing are described more or less diagrammatically in the accompanying drawings, wherein:

FIG. 1 is an isometric view of a fluid mixer according to the present disclosure.

FIG. 2 is a perspective view of the fluid mixer of FIG. 1, with the outer frame and panels removed for clarity.

FIG. 3 is a side elevation view of the fluid mixer of FIG. 1, with the outer frame and panels removed for clarity.

FIG. 4 is an isometric view of an agitator frame assembly of the fluid mixer of FIG. 1.

FIG. 5 is a front view of the agitator frame assembly of FIG. 4.

FIG. 6 is an enlarged bottom perspective view of a clamp base of the fluid mixer of FIG. 1, showing a bail retainer according to the present disclosure.

FIGS. 7A and 7B are isometric views of the clamp base shown in FIG. 6, with the bail retainer in the retracted and extended positions, respectively.

FIGS. 8A and 8B are isometric views of a clamp base showing an alternative embodiment of the bail retainer according to the present disclosure.

FIG. 9 is a bottom perspective view showing another alternative embodiment of the bail retainer according to the present disclosure.

FIGS. 10A and 10B are isometric views of a clamp base used in the bail retainer shown in FIG. 9, with the bail retainer in the retracted and extended positions, respectively.

It should be understood that the drawings are not necessarily to scale and that the disclosed embodiments are illustrated using diagrammatic representations and fragmentary views. In certain instances, details may have been omitted which are not necessary for an understanding of the disclosed embodiments or which render other details difficult to perceive. It should be understood, of course, that the disclosed bail retainers, paint mixers and methods of mixing are not necessarily limited to the particular embodiments disclosed herein.

### DETAILED DESCRIPTION

A bail retainer is disclosed for maintaining the bail or handle of a container in a substantially fixed position relative to the container during mixing. The bail retainer is described herein in conjunction with a vibratory paint mixer having an adjustable clamp for holding the container during operation. It will be appreciated, however, that the bail retainer disclosed and claimed herein is not limited to this specific application, but instead may be used with any mixing apparatus for any type of fluid that may benefit from the advantages disclosed herein.

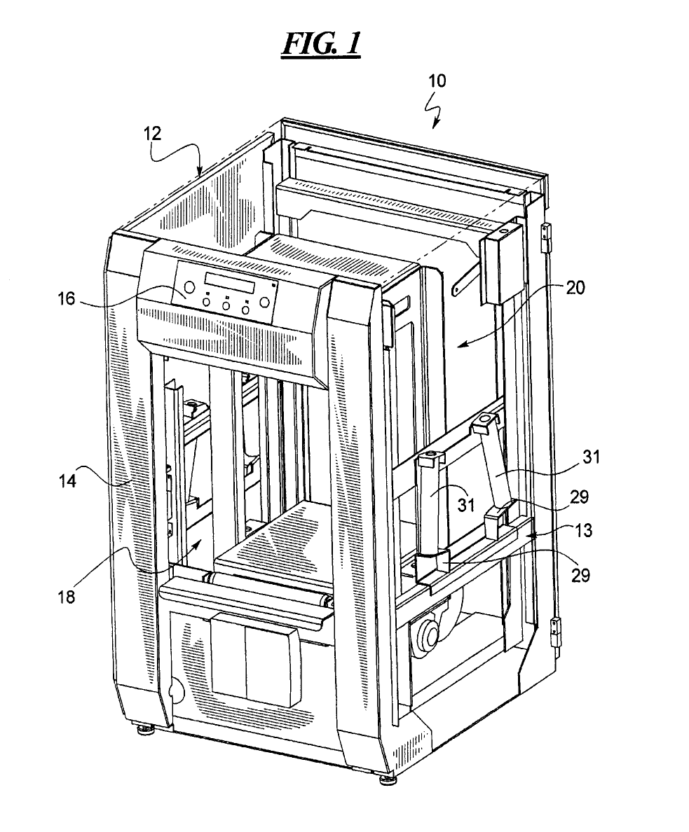

Referring first to FIG. 1, a mixing apparatus 10 is shown having an outer enclosure 12 attached to an outer frame 13. The outer enclosure 12 includes a front panel 14 having a controls area 16 in which may be provided input devices (such as switches and knobs) and output devices (such as a timer) for controlling and monitoring operation of the mixer. The front panel also includes an access window 18 through which a user may access an interior of the enclosure 12.

An inner frame assembly 15 is coupled to the outer frame 13, as best shown in FIGS. 1-3. The inner frame assembly 15 includes a base plate 17, two rear vertical supports 19, two front vertical supports 21, two side horizontal supports 23, and a cross support 25. Two brackets 27 extend outwardly from each side horizontal support 23. As best shown in FIG. 1, the outer frame 13 includes four base brackets 29, each base bracket 29 being associated with a side support bracket 27. A strut 31 is positioned between each base bracket/side support bracket pair for a total of four struts in the illustrated embodiment. The struts 31 minimize vibrations imparted to the surrounding area during operation of the mixer 10, as understood more fully below.

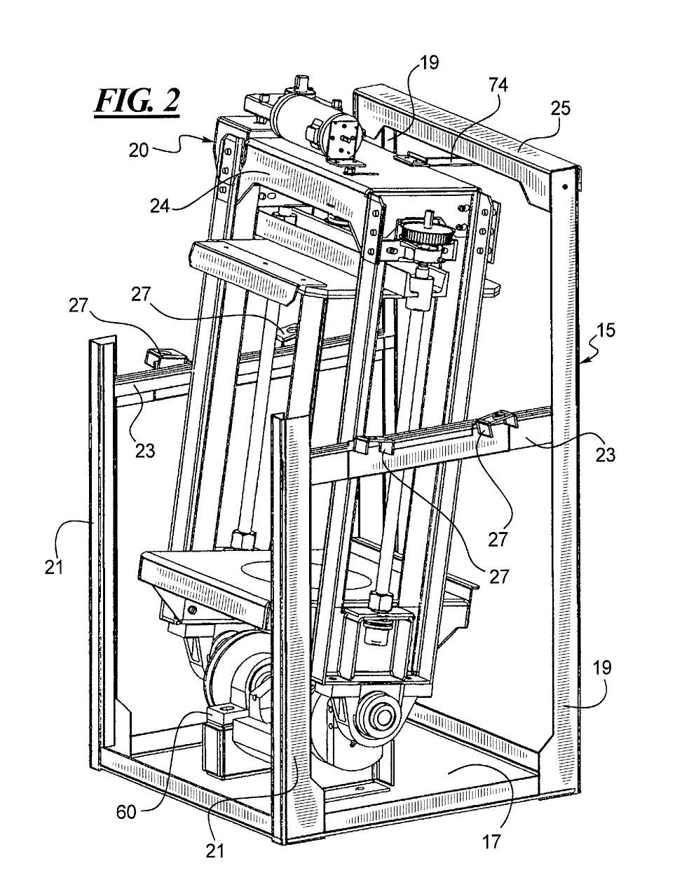

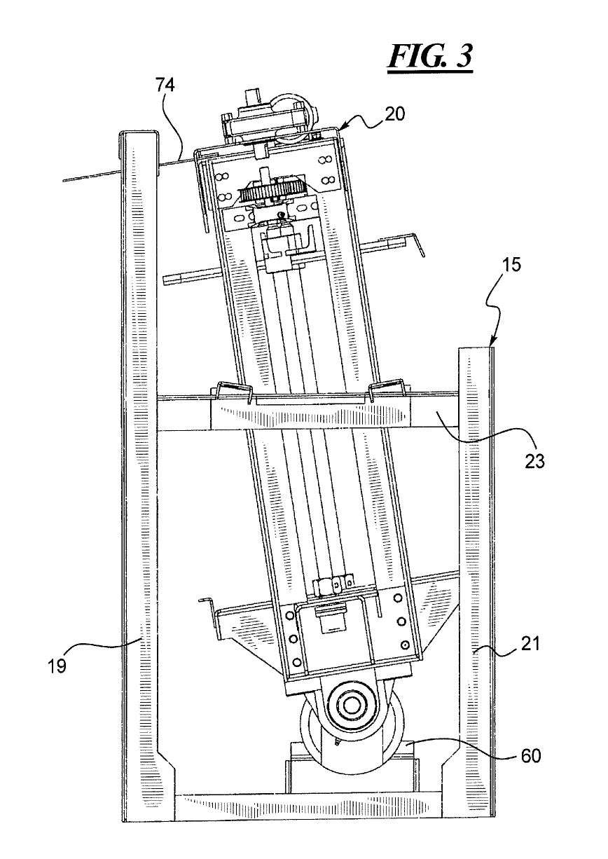

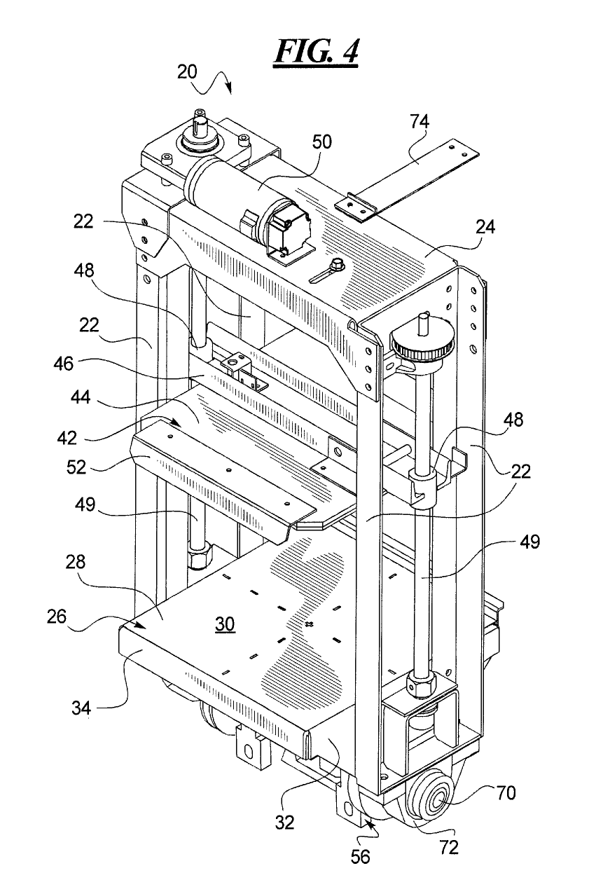

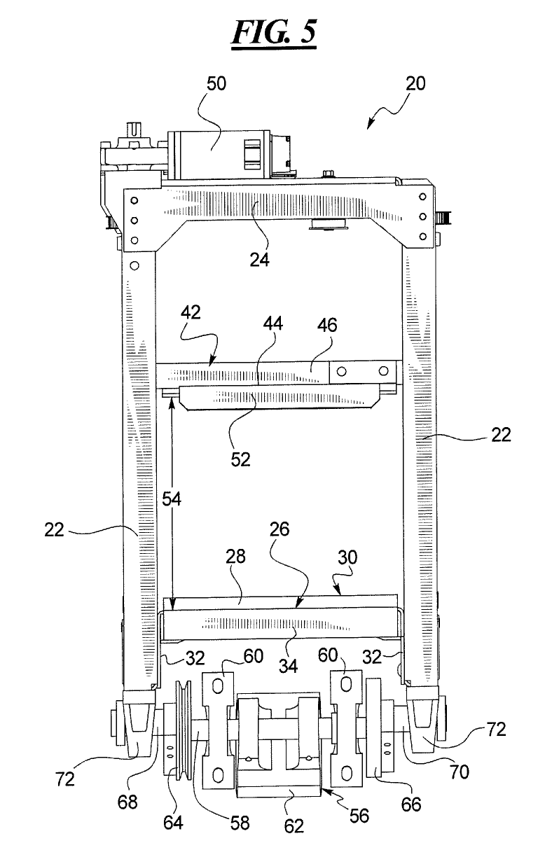

An agitator frame assembly 20 is coupled to the inner frame assembly 15 and disposed inside the enclosure 12 for securing one or more containers and for generating a reciprocating force that agitates the contents of the container(s). The containers may have a cylindrical, rectangular, square, or other known shape, and may be provided in any size, such as pint, quart, gallon, five gallon, or other known sizes. Furthermore, the containers may be formed of metal, plastic, a combination of metal and plastic, or other known material or combination of materials. As best illustrated in FIGS. 4 and 5, the agitator frame assembly 20 includes spaced pairs of side supports 22, the top ends of which are connected by a cross member 24. Furthermore, while the agitator frame assembly 20 is illustrated in FIGS. 2 and 3 as being oriented at an angle with respect to the inner frame 15, it will be appreciated that the agitator frame assembly 20 may be oriented at angles other than that specifically shown, including in an orientation that is substantially parallel to the vertical members of the inner frame 15.

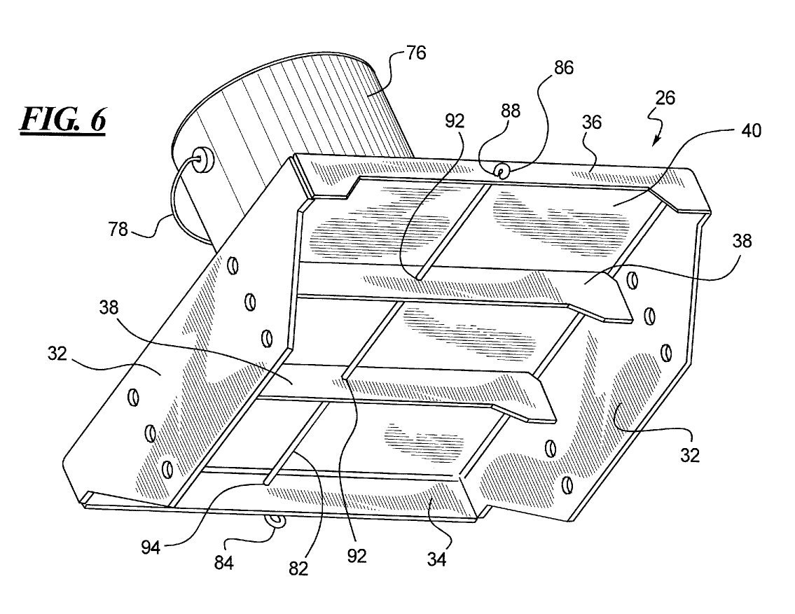

A stationary clamp base 26 is attached to and extends between bottom portions of the side supports 22. In the illustrated embodiment, the clamp base 26 has a top plate 28 defining an upper surface 30 with a generally rectangular shape, and includes two side panels 32, a front wall 34, and a rear wall 36 depending therefrom. Braces 38 are attached to a bottom surface 40 of the top plate 28 and extend between the side panels 32 (FIG. 6).

An upper clamp assembly 42 is disposed above the clamp base 26 and is movable in a vertical direction to adjust the spacing between the clamp base 26 and 42, thereby to accommodate containers of various sizes and to exert the desired clamping force on the container lid. As best shown in FIGS. 4 and 5, the upper clamp member 42 includes a plate 44 having a generally rectangular shape and a channel 46 attached to a top face of the plate 44. A threaded coupling 48 is attached to each end of the channel 46 and is sized to receive a threaded rod 49. A motor 50 is operably coupled to the threaded rods 49 for rotating the rods in either the clockwise or counter-clockwise direction, thereby raising or lowering the upper clamp member 42 with respect to the clamp base 26. The upper clamp member 42 may also include a front lip 52 attached to the plate 44.

The clamp base 26 and upper clamp member 42 form an adjustable clamp for securely holding containers during operation of the mixer 10. A clamping area 54 is defined between the clamp base 26 and upper clamp member 42. Accordingly, a height of the clamping area 54 will vary with the position of the upper clamp member 42 with respect to the clamp base 26, thereby allowing the adjustable clamp to accommodate containers of various heights. In addition, the open frame construction of the agitator frame assembly 20 accommodates various container sizes and shapes.

An eccentric drive 56 is coupled to a bottom of the agitator frame assembly 20 for driving the agitator frame assembly in a reciprocating motion. As illustrated in FIGS. 4 and 5, the eccentric drive 56 includes a drive shaft 58 supported for rotation by two bearings 60. The bearings 60 may be pillow block bearings that are coupled to the bottom plate 17 of the inner frame assembly 15. A counterweight 62 is coupled to the drive shaft 58. A pulley 64 is attached to one end of the drive shaft 58 adapted to be rotatably driven, such as be a belt coupled to a motor (not shown). A coupling 66 is coupled to the end of the drive shaft 58 opposite the pulley 64. First and second stub shafts 68, 70 are coupled to the pulley 64 and coupling 66, respectively. The stub shafts 68, 70 are aligned to have substantially the same axis, but are offset from an axis of the drive shaft 58, so that the stub shafts 68, 70 are eccentrically mounted with respect to the drive shaft 58. Outer ends of the stub shafts 68, 70 are rotatably received by bearings, such as pillow block bearings 72, coupled to the bottom ends of the side supports 22. As a result, rotation of the drive shaft 58 causes the stub shafts 68, 70 to revolve about an axis of the drive shaft 58, thereby driving the agitator frame assembly 20 in a reciprocating motion. The maximum displacement, or stroke, of the eccentric drive is determined by the distance between the drive shaft axis and the stub shaft axis.

The top of the agitator frame assembly 20 is secured to the inner frame assembly 15 by a flexible link. For example, a slat 74 may have a first end attached to the cross member 24 of the agitator frame assembly 20 and a second end coupled to the cross member 25 of the inner frame assembly 15. The slat 74 may be flexible to act like a leaf spring, thereby to accommodate movement of the agitator frame assembly 20 during operation of the mixer 10. Accordingly, the bottom end of the agitator frame assembly 20 is secured to the inner frame assembly 15 by the bearings 60 which receive the drive axis 58 and the top end of the agitator frame assembly 20 is secured to the inner frame assembly 15 by the slat 74, thereby maintaining the agitator frame assembly 20 in an upright orientation.

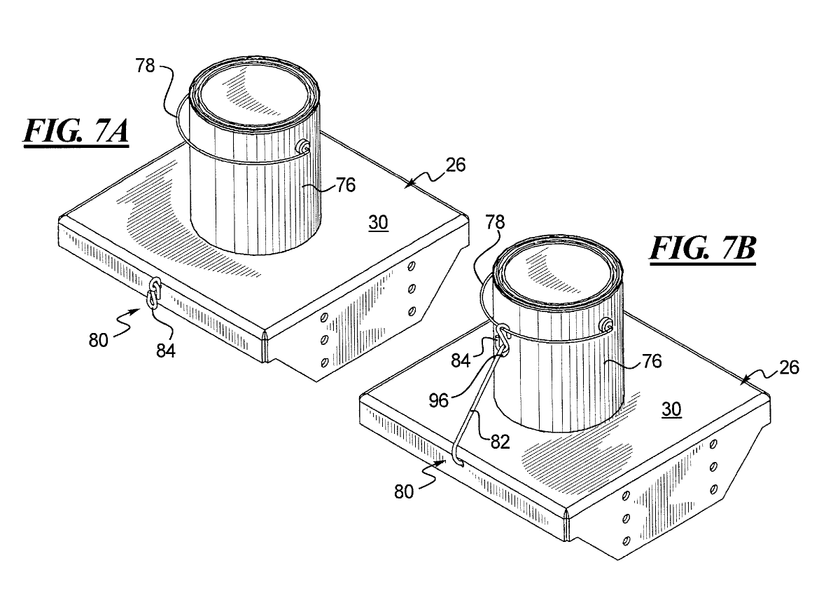

A bail retainer is provided for securing the bail or handle of a container placed in the adjustable clamp. As illustrated in FIGS. 6 and 7A-B, the upper surface 30 of the clamp base 26 supports a container 76. A bail or handle 78 is pivotably attached to the container 76, and therefore is free to move during operation of the mixer 10 if unrestrained. The bail retainer, however, secures the bail 78 in a substantially fixed position with respect to the container 76 during mixing. In general, the bail retainer includes an elastic member having at least one fixed portion coupled to the mixing apparatus 10 and a free portion, to which a fastener is attached.

The elastic member is movable between a retracted position, in which the elastic member free portion is outside of the clamping area 54, and an extended position, in which the elastic member free portion is disposed within the clamping area 54. When in the retracted position, the elastic member preferably has sufficient tension to maintain a substantially fixed point of contact with the mixing apparatus 10. The extended position of the elastic member allows the fastener to be coupled to the container bail 78. In the extended position, the elastic member generates a tension force sufficient to hold the bail 78 in a restrained position, such that the orientation of the bail 78 with respect to the container 76 remains substantially constant during operation of the mixing apparatus 10. The tension force should not be so large, however, that it is overly difficult to move the elastic member to the extended position or that it pulls or displaces the container 76 when the fastener is attached to the bail 78. When the bail is in the restrained position, it may engage the container 76 or may be held away from the container. Whether the bail 78 contacts or is spaced from the container 76 is dependent largely on the geometry of the mixing apparatus structure and the location of the container within that structure, as will be more fully understood below.

One embodiment of a bail retainer 80 is illustrated in FIGS. 6, and 7A-B. The bail retainer 80 includes an elastic member 82 and a fastener 84. The elastic member 82 has a fixed end 86 that is coupled to the rear wall 36 of the clamp base 26 (FIG. 6). The fixed end 86 may be secured to the rear wall 36 in any known manner, such as by threading the fixed end 86 through an aperture 88 formed in the rear wall and tying a knot so that the fixed end does not slide back through the aperture 88. Where braces 38 are provided on the bottom surface 40 of the plate 28, as illustrated in FIG. 6, each brace 38 may be formed with an aperture 92 to allow the elastic member 82 to pass therethrough. The front wall 34 of the clamp base 26 also includes an aperture 94 sized to receive the elastic member 82. The fastener 84 is coupled to a free end 96 of the elastic member 82 and has a profile that prevents it from passing through the front wall aperture 94.

The elastic member 82 is selected so that it is sufficiently elastic to extend from the retracted position, in which the elastic member free portion is outside of the clamping area 54, to an extended position, in which the elastic member free portion is disposed within the clamping area 54 so that the fastener may be coupled to the container bail. In the retracted position (FIG. 7A), the elastic member 82 withdraws through the front wall aperture 94 until the fastener 84 contacts the front wall 34 adjacent the aperture 94. In this position, the elastic member 82 preferably generates a sufficient tension force to hold the fastener 84 in substantially the same position during operation of the mixer, should the user elect not to use the retainer. The elastic member 82 is sufficiently elastic to extend from the relaxed position to the extended position illustrated in FIG. 7B, in which the fastener 84 is disposed within the clamping area 54 and may be coupled to the container bail 78. In the extended position, the elastic member 82 has sufficient tension to maintain the bail 78 in a substantially fixed position relative to the container 76. In the illustrated embodiment, the bail 78 is maintained in a position such that it does not contact the container 76.

In an alternative embodiment, a bail retainer 100 includes an elastic member 102 and a fastener 104. The elastic member 102 is formed as a loop that is threaded through two eyebolts 106 connected to the front wall 34 of the clamp base 26, thereby to form a double-stranded elastic member. Accordingly, the elastic member 102 includes two fixed portions, namely the end portions of the elastic member 102 that are secured by the eyebolts 106. A middle portion 108 of the elastic member 102 is defined between the two fixed portions, and is free to move relative to the fixed end portions. The fastener 104 is coupled to the middle portion 108.

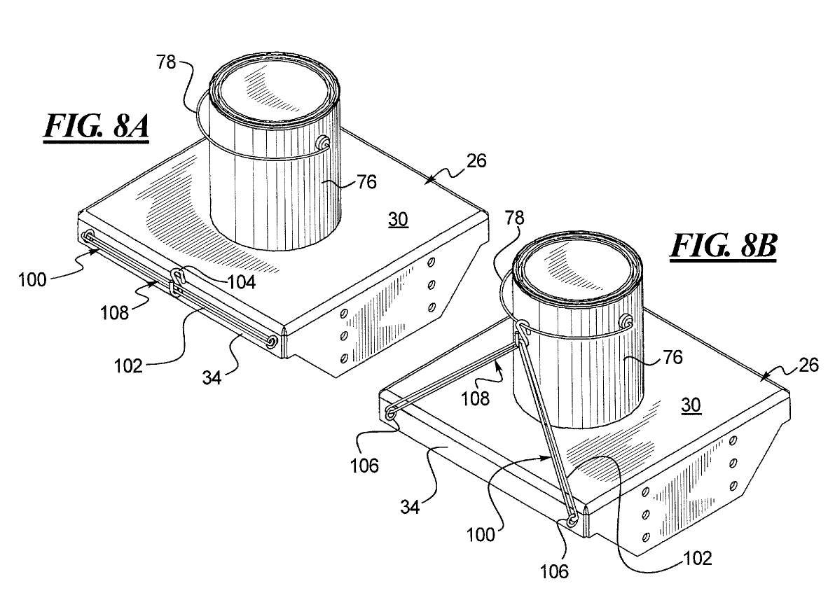

In a retracted position, the elastic member 102 and fastener 104 are withdrawn from the clamping area 54 and preferably overlie the base clamp front wall 34, as illustrated in FIG. 8A. In the extended position, the middle portion 108 and fastener 104 are extended into the clamping area 54 to allow the fastener 104 to be attached to the bail 78 of the container 76.

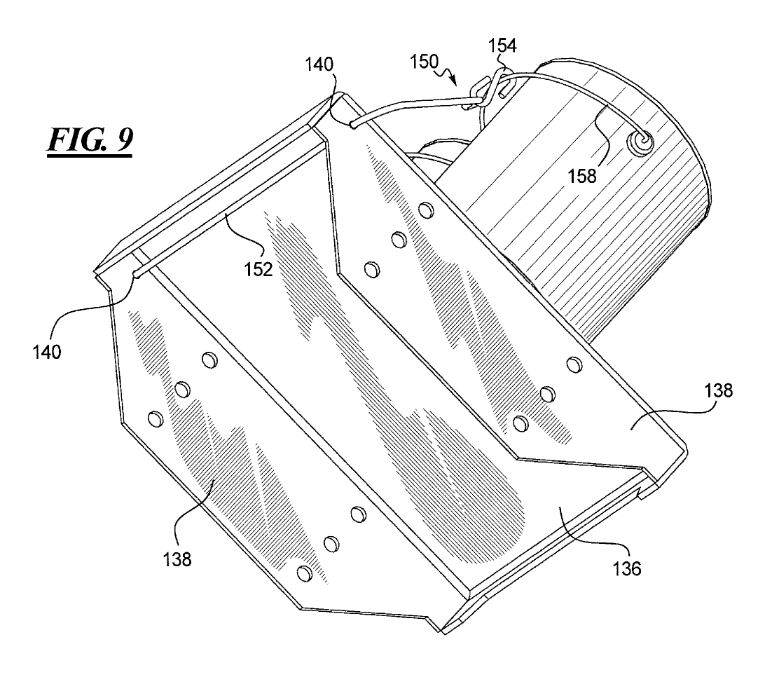

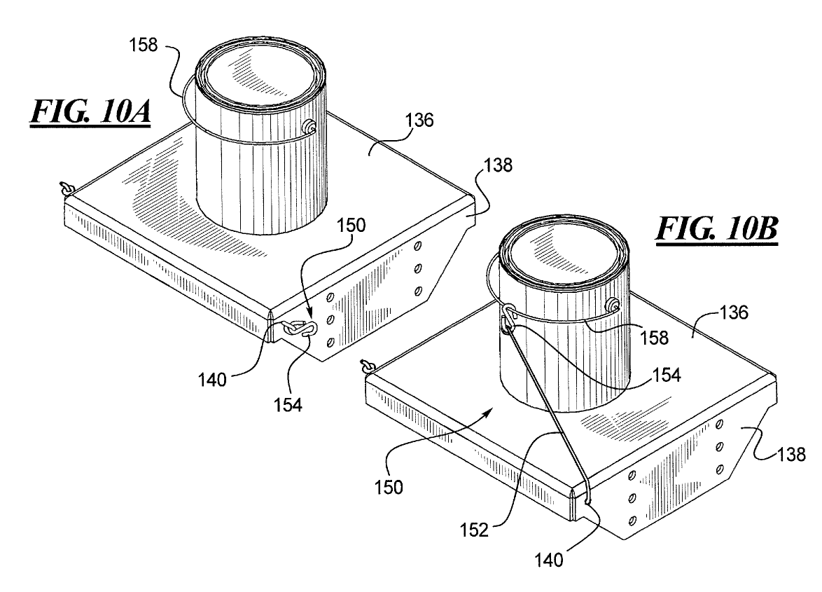

A third embodiment of the bail retainer is illustrated in FIGS. 9, 10A, and 10B. In this embodiment, a clamp base 136 includes side walls 138, each side wall 138 including an aperture 140. The bail retainer 150 includes an elastic member 152 sized for insertion through the apertures 140. A first end of the elastic member 152 is fixed to the clamp base 136 by inserting the end through a side wall 140 and tying a knot that is large enough so that knotted first end cannot pass through the aperture 140. An opposite end of the elastic member defines a free portion, and a fastener 154 is attached to the free end. The free end of the elastic member 152 is movable between a retracted position (FIG. 10A) and an extended position (FIG. 10B). In the retracted position, the free end is positioned outside of the clamping area. In the extended position, the free end is disposed within a clamping area so that the fastener 154 may be attached to a container bails 158.

While a single bail is retained in the foregoing embodiments, it may be possible to secure more than one bail with a single elastic member, to accommodate multiple containers simultaneously placed on the clamp base. For example, the embodiment illustrated in FIGS. 9, 10A, and 10B may be modified so that the first end of the elastic member 152 is not knotted but instead is also movable to define a second free portion of the elastic member. A second fastener may then be coupled to the second free portion, which is also movable between the retracted and extended positions. In the extended position, the second free portion is disposed with the clamping area to allow the second fastener to be attached to a bail of a second container placed on the clamp base 136. As used herein, the term “fixed portion” includes a portion of the elastic member that is generally secured or held in place. Accordingly, in this modified, two fastener embodiment, the elastic member has two fixed portions when in the extended position even though both ends are slidable through the apertures when in the retracted position. Specifically, the fixed portions are the portions of the elastic member 152 that engage the apertures 140 when the elastic member is in the extended position, as best shown in FIG. 10B. The elastic member may be selected so that sufficient tension is created to secure the elastic member in position.

In the embodiments disclosed herein, the material, size, and length of the elastic member are selected to display the desired characteristics noted above. Currently preferred materials for the elastic member include, but are not limited to, bungee cord, shock cord, and polyurethane cord.

While the foregoing was written with reference to specific examples and embodiments, it is to be understood that the scope of the disclosure is not to be limited thereby. Instead, the detailed description is provided to satisfy best mode and enablement requirements while providing support for any and all claims which may issue herefrom.

What is claimed is:

1. A bail retainer for a fluid mixer having a clamping area adapted to receive at least one container having a pivoting bail, the bail retainer comprising:
an elastic member having a first fixed portion retained by the fluid mixer and a first free portion; and
a fastener coupled to the elastic member first free portion;
wherein the elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

2. The bail retainer of claim 1, in which the fluid mixer includes a clamp base having an upper surface adapted to support a bottom of the container, and in which the first fixed portion of the elastic member is retained by the clamp base.

3. The bail retainer of claim 2, in which the clamp base further includes front and rear walls depending from the upper surface, the front wall including an aperture, and in which the elastic member first fixed portion is coupled to the rear wall and includes a middle portion passing through the front wall aperture.

4. The bail retainer of claim 3, in which the elastic member is sized so that the fastener engages the front wall aperture when the elastic member is in the retracted position.

5. The bail retainer of claim 1, in which the elastic member further includes a second fixed portion retained by the fluid mixer.

6. The bail retainer of claim 5, in which the elastic member includes a middle portion disposed between the first and second fixed portions, and in which the middle portion includes the free portion.

7. The bail retainer of claim 5, in which an end of the elastic member comprises the first free portion.

8. The bail retainer of claim 5, in which the fluid mixer includes a clamp base having an upper surface adapted to support a bottom of the at least one container, and in which the first and second fixed portions of the elastic member are retained by the clamp base.

9. The bail retainer of claim 1, in which the fastener comprises a securing end coupled to the elastic member free portion and a hook adapted to engage the container bail.

10. The bail retainer of claim 1, in which the fluid mixer includes a clamp base having an upper surface adapted to support a bottom of the at least one container and first and second side walls depending from lateral edges of the upper surface, and in which a first end of the elastic member is attached to the first side wall to form the first fixed portion, an opposite end of the elastic member is the first free portion, and a middle portion of the elastic member disposed between the first fixed portion and first free portion passes through an aperture formed in the second side wall.

11. A fluid mixer for use with at least one container having a pivoting bail, the fluid mixer comprising:
a clamp assembly including a clamp base having an upper surface adapted to support a bottom of the container and a top plate adapted to engage a top of the container, wherein the top plate is movable to adjust an axial spacing between the clamp base and the top plate and provide a clamping force on the container when disposed therebetween, a clamping area being defined between the clamp base and the top plate;
a drive operably coupled to the clamp assembly; and
a bail retainer including an elastic member having a first fixed portion retained by the fluid mixer and a first free portion, and a fastener coupled to the elastic member first free portion;
wherein the elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

12. The fluid mixer of claim 11, in which the first fixed portion of the elastic member is secured to the clamp base.

13. The fluid mixer of claim 11, in which the clamp base further includes front and rear walls depending from the upper surface, the front wall including an aperture, and in which the elastic member first fixed portion is coupled to the rear wall and includes a middle portion passing through the front wall aperture.

14. The fluid mixer of claim 13, in which the elastic member is sized so that the fastener engages the front wall aperture when the elastic member is in the retracted position.

15. The fluid mixer of claim 11, in which the elastic member further includes a second fixed portion retained by the fluid mixer to define a middle portion between the fixed portions, and in which the middle portion includes the free portion.

16. The fluid mixer of claim 11, in which the elastic member includes a second fixed portion retained by the fluid mixer, and in which an end of the elastic member comprises the first free portion.

17. The fluid mixer of claim 11, in which the fluid mixer clamp base further includes first and second side walls depending from lateral edges of the upper surface, and in which a first end of the elastic member is attached to the first side wall to form the first fixed portion, an opposite end of the elastic member is the first free portion, and a middle portion of the elastic member disposed between the first fixed portion and first free portion passes through an aperture formed in the second side wall.

18. A fluid mixer for use with at least one container having a pivoting bail, the fluid mixer comprising:
a clamp base having an upper surface adapted to support a bottom of the at least one container and opposed first and second side walls depending from the upper surface, each of the first and second side walls including an aperture;
a top plate adapted to engage a top of the at least one container, wherein the top plate is movable to adjust an axial spacing between the clamp base and the top plate and provide a clamping force on the container when disposed therebetween, a clamping area being defined between the clamp base and the top plate;
a drive operably coupled to the clamp assembly; and
an elastic member sized for insertion through the side wall apertures, whereby engagement between the elastic member and the apertures in the first and second side walls define first and second fixed portions of the elastic member, the elastic member further including at least one free portion; and
a fastener coupled to the elastic member first free portion;
wherein the elastic member is sufficiently elastic to move from a retracted position, in which the elastic member first free portion is outside of the clamping area, and an extended position, in which the elastic member first free portion is disposed within the clamping area so that the fastener may be coupled to the at least one container bail.

19. The fluid mixer of claim 18, in which the fluid mixer clamp base further includes first and second side walls depending from lateral edges of the upper surface, and in which a first end of the elastic member is attached to the first side wall to form the first fixed portion, an opposite end of the elastic member is the first free portion, and a middle portion of the elastic member disposed between the first fixed portion and first free portion passes through an aperture formed in the second side wall.

20. The fluid mixer of claim 18, in which the fastener comprises a securing end coupled to the elastic member free portion and a hook adapted to engage the container bail.
